(19) United States
(12) Patent Application Publication
(10) Pub. No.: US 2015/0277593 A1
(43) Pub. Date: Oct. 1, 2015

(54) Thumb Stylus for Capacitive Touch Screens

(71) Applicant: Ryan Martin, Lititz, PA (US)

(72) Inventor: Ryan Martin, Lititz, PA (US)

(21) Appl. No.: 14/676,708

(22) Filed: Apr. 1, 2015

Related U.S. Application Data
(60) Provisional application No. 61/973,540, filed on Apr. 1, 2014.

(51) Int. Cl. G06F 3/0354; G06F 3/044

(52) U.S. Cl. CPC G06F 3/03545; G06F 3/044

(57) ABSTRACT

A thumb or finger extension device for touchscreen use may be manufactured in a generic shape or may be custom-fitted to a particular user's thumb or finger, for example to accommodate a user who has lost all or part of the thumb or other finger. The device, whether generic or custom-fitted, fits firmly and comfortably on the thumb or finger. In a second embodiment, the device provides one or more bands for affixing the device on the thumb or other finger of a user. Each embodiment is manufactured from a flexible material, and provides a protrusion at the center of the bulb of the device, which may be used to operate the touchscreen and the keys of a smartphone or other electronic device.

### CROSS-REFERENCE TO RELATED APPLICATIONS

This application claims the benefit of U.S. Provisional Application No. 61/973,540, filed Apr. 1, 2014, which is hereby incorporated by reference.

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to accessories for electronic devices and in particular to a thumb extension device for capacitive touchscreen use. For some users of smartphones and other electronic devices, using a touchscreen or typing a text message is very difficult due to the dexterity of their fingers. For many other users, such tasks are challenging due to the small size of the keys and the display screen. An extension device for touchscreen use, which is temporarily affixed to the user's thumb or other finger and provides a protrusion for the use of electronic devices, would resolve this problem.

### SUMMARY OF THE INVENTION

Accordingly, the invention is directed to a thumb or finger extension device for touchscreen use. The device may be manufactured in a generic shape or may be custom-fitted to a particular user's thumb or finger, for example to accommodate a user who has lost all or part of the thumb or other finger. The device, whether generic or custom-fitted, fits firmly and comfortably on the thumb or finger. In a second embodiment, the device provides one or more bands for affixing the device on the thumb or other finger of a user. Each embodiment is manufactured from a flexible material, and provides a protrusion at the center of the bulb of the device, which may be used to operate the touchscreen and the keys of a smartphone or other electronic device.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWINGS

The accompanying drawings are included to provide a further understanding of the invention and are incorporated into and constitute a part of the specification. They illustrate two embodiments of the invention and, together with the description, serve to explain the principles of the invention.

FIG. 1 is a side view of the first exemplary embodiment, displaying the device 10, the closed end 10A, the open end 10B, the aperture 11, the bulb 12, and the protrusion 13.

FIG. 2 is a side view of the second exemplary embodiment, displaying the device 10, the closed end 10A, the open end 10B, the bulb 12, the protrusion 13, the cavity 14, and the bands 15.

FIG. 3 is a side view of the second exemplary embodiment affixed to the user's thumb, displaying the device 10, the bulb 12, the protrusion 13, the bands 15, and the thumb 16.

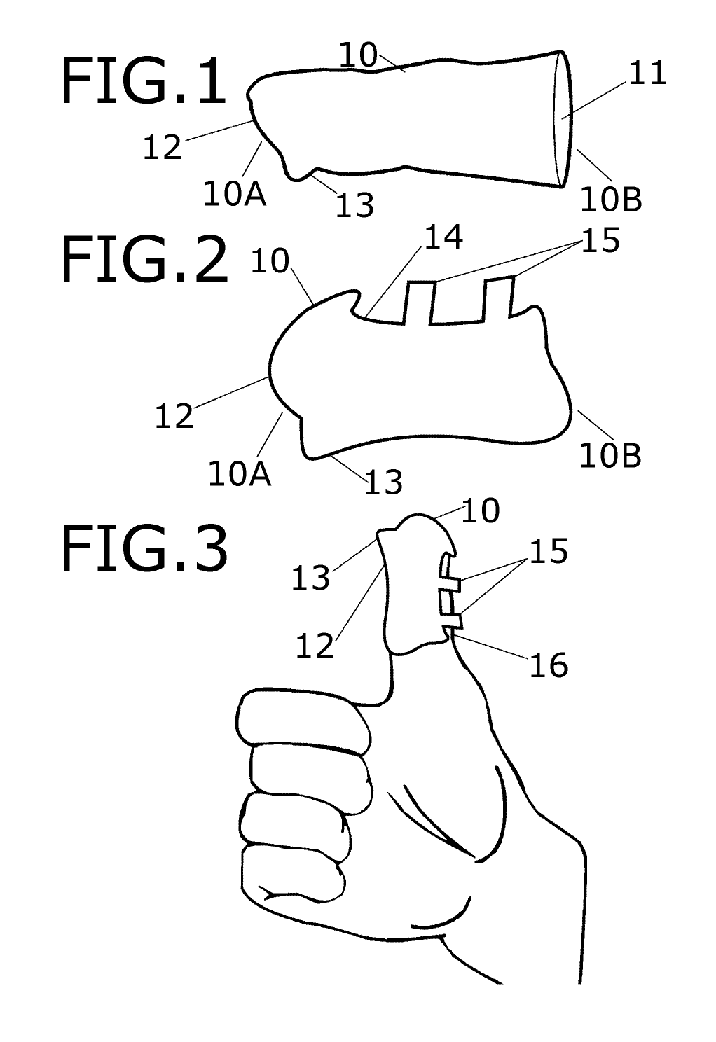

### DETAILED DESCRIPTION OF THE INVENTION

Referring now to the invention in more detail, the invention is directed to a thumb or finger extension device 10 for touchscreen use. As shown, the device 10 lacks any closure and does not separate from itself, collapse, or unfold. The device 10 is custom-fitted to accommodate a user who has lost all or part of the thumb or finger, and fits firmly and comfortably on the remaining tissue. In a second embodiment, the device 10 provides one or more bands 15 for affixing the device on the thumb 16 of a user who has not been injured, but may lack the dexterity to use an electronic device with a small keyboard and a small touchscreen. Each embodiment is manufactured from a flexible material, and provides a protrusion 13 at the center of the bulb 12 of the device 10, which may be used to operate the touchscreen and the keys of a smartphone or other electronic device.

The first exemplary embodiment provides a thumb-shaped device 10, which may be manufactured in a generic shape or may be custom-fitted to a particular user, for example to fit on the remaining tissue of a user who has lost all or part of a thumb or finger. The device 10 provides a fitted aperture 11 at its open end 10B wherein the thumb or finger of the user is inserted.

The second exemplary embodiment provides a thumb-shaped device 10 having a cavity 14, accessed via the open end 10B, which fits on the tip of the thumb 16, and provides one or more nondetachable bands 15 (the bands 15 lack any closure), which slide over the user's thumbnail and secure the device to the thumb 16 by providing tension over the thumb 16.

Both the first and second exemplary embodiments provide a rounded, lifelike bulb 12 (shaped as a facsimile of the tip of a human digit) at the closed end 10A of the device 10. At the center of the bulb 12 is a protrusion 13, which may be used to operate a touchscreen or keyboard on a tablet, smartphone, or other electronic device. The protrusion 13 provides an electrically conductive pathway between the user's hand and a capacitive touchscreen (generically, between the interior and exterior of the device 10), thus allowing the device 10 to interact with capacitive touchscreens. The protrusion is preferably blunt (not sharp) and shaped as a swept, rounded, cone, as shown.

To use the first exemplary embodiment, the user inserts the thumb or finger into the aperture 11, and may then use the protrusion 13 to operate the touchscreen or keyboard of the electronic device.

To use the second exemplary embodiment, the user inserts the tip of the thumb 16 or finger under the bands 15 such that the bands 15 are across the user's thumbnail. This positions the tip of the thumb 16 in the cavity 14. The user may then use the protrusion 13 to operate the touchscreen or keyboard of the electronic device.

The device 10 is preferably manufactured from a flexible, durable material with a slight degree of elasticity. The material is preferably electrically conductive to permit the use of capacitive touch screens. Components, component sizes, and materials listed above are preferable, but artisans will recognize that different components and materials could be employed without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. A thumb stylus comprising a thumb-shaped device; said thumb-shaped device lacking any closure and unable to separate from itself, collapse, or unfold; said thumb shaped device having a closed end and an open end; a bulb; said bulb being shaped as a facsimile of the tip of a human digit; said bulb being a portion of said thumb-shaped device located at said closed end; a protrusion; said protrusion being a portion of said thumb-shaped device located at the center of said bulb; said protrusion providing an electrically conductive pathway; and said protrusion being blunt and shaped as a swept, rounded cone.

2. The thumb stylus of claim 1 further comprising a fitted aperture; said fitted aperture being a part of said thumb-shaped device located at said open end; and said fitted aperture being configured for attachment to remnants of partially lost human thumbs.

3. The thumb stylus of claim 2 wherein said fitted aperture is custom-fitted.

4. The thumb stylus of claim 1 further comprising a cavity; said cavity being within and a part of said thumb-shaped device; said cavity being accessed via said open end; and said cavity being configured to accommodate a human thumb.

5. The thumb stylus of claim 4 further comprising a plurality of bands; said plurality of bands being nondetachably affixed to said thumb-shaped device; and said plurality of bands lacking any closure.
